(19) United States
(12) Patent Application Publication
(10) Pub. No.: US 2007/0019758 A1
(43) Pub. Date: Jan. 25, 2007

(54) Method and apparatus for processing multiple adjacent radio frequency channels simultaneously

(75) Inventors: Tanbir Haque, Jackson Heights, NY (US); Leonid Kazakevich, Plainview, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/473,908

(22) Filed: Jun. 23, 2006

Related U.S. Application Data
(60) Provisional application No. 60/702,199, filed on Jul. 25, 2005.

(51) Int. Cl. H04L 27/00

(52) U.S. Cl. 375/316

(57) ABSTRACT

A method and apparatus of processing multiple adjacent radio frequency (RF) channels simultaneously are disclosed. The apparatus includes an analog front end, a local oscillator (LO), a mixer, a filter, an analog-to-digital converter (ADC) and a Hilbert transformer. Received RF signals including a plurality of channels adjacent to each other in frequency are processed by the analog front end. The received RF signals are mixed with the LO signals by the mixer to generate down-converted signals. A frequency of the LO signals is tuned such that at least two channels in the down-converted signals overlap each other. The down-converted signals are filtered and digitized by the ADC. The digitized signals are then processed by the Hilbert transformer for recovering signals on each of the RF channels.

### CROSS REFERENCE TO RELATED APPLICATION

This application claims the benefit of U.S. Provisional Application No. 60/702,199 filed Jul. 25, 2005, which is incorporated by reference as if fully set forth.

### FIELD OF INVENTION

The present invention is related to a wireless communication system. More particularly, the present invention is related to a method and apparatus for processing multiple adjacent radio frequency (RF) channels simultaneously.

### BACKGROUND

Currently, most wireless transmit/receive units (WTRUs) typically utilize a multi-band, direct down-conversion to convert received RF signals to baseband signals. A plurality of analog components, such as switches, multiplexers and filters, are used in the analog front end of a receiver to select a desired bandwidth of the signals. In order to select the desired bandwidth, a frequency synthesizer is programmed to generate a local oscillator (LO) signal at a frequency in the middle of the desired channel. After implementing the appropriate lowpass filtering, the down-converted baseband signal is then converted to a digital signal by an analog-to-digital converter (ADC). A lowpass filter selects desired signals and rejects all other down-converted baseband signals.

A conventional receive chain in a receiver only processes one channel of interest at a time. In order to process multiple channels simultaneously, multiple receive chains should be provided. Therefore, it is desirable to provide a method and apparatus capable of processing multiple adjacent channels simultaneously with one receive chain.

### SUMMARY

The present invention is related to a method and apparatus for processing multiple adjacent RF channels simultaneously. The apparatus includes an analog front end, an LO, a mixer, a filter, an ADC and a Hilbert transformer. Received RF signals, including a plurality of channels adjacent to each other in frequency, are processed by the analog front end. The received RF signals are mixed with the LO signals by the mixer to generate down-converted signals. A frequency of the LO signals is tuned such that at least two channels in the down-converted signals overlap each other. The down-converted signals are filtered by the filter and digitized by the ADC. The digitized signals are then processed by the Hilbert transformer for recovering signals on each of the RF channels.

The LO and the filter may be software configurable, such that the apparatus may selectively process the received signals in a single channel mode or a dual channel mode by configuring a frequency of the LO signals and the bandwidth of the filter. The down-converted signals may be alternating current (AC)-coupled to the ADC or may be selectively either direct current (DC)-coupled or AC-coupled.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a block diagram of a receiver for processing two adjacent channels simultaneously in accordance with the present invention;

FIG. 2A shows an RF spectrum of two adjacent channels;

FIG. 2B shows a down-converted baseband spectrum of two adjacent channels;

FIG. 3A shows baseband filtering requirements in a dual channel mode; and

FIG. 3B shows baseband filtering requirements in a single channel mode.

### DETAILED DESCRIPTION OF THE PREFERRED EMBODIMENTS

The present invention will be described with reference to the drawing figures wherein like numerals represent like elements throughout.

The present invention is applicable to a WTRU and a base station. The terminology “WTRU” includes but is not limited to a user equipment (UE), a mobile station, a fixed or mobile subscriber unit, a pager, or any other type of device capable of operating in a wireless environment. The terminology “base station” includes but is not limited to a Node-B, a site controller, an access point or any other type of interfacing device in a wireless environment.

The features of the present invention may be incorporated into an integrated circuit (IC) or be configured in a circuit comprising a multitude of interconnecting components.

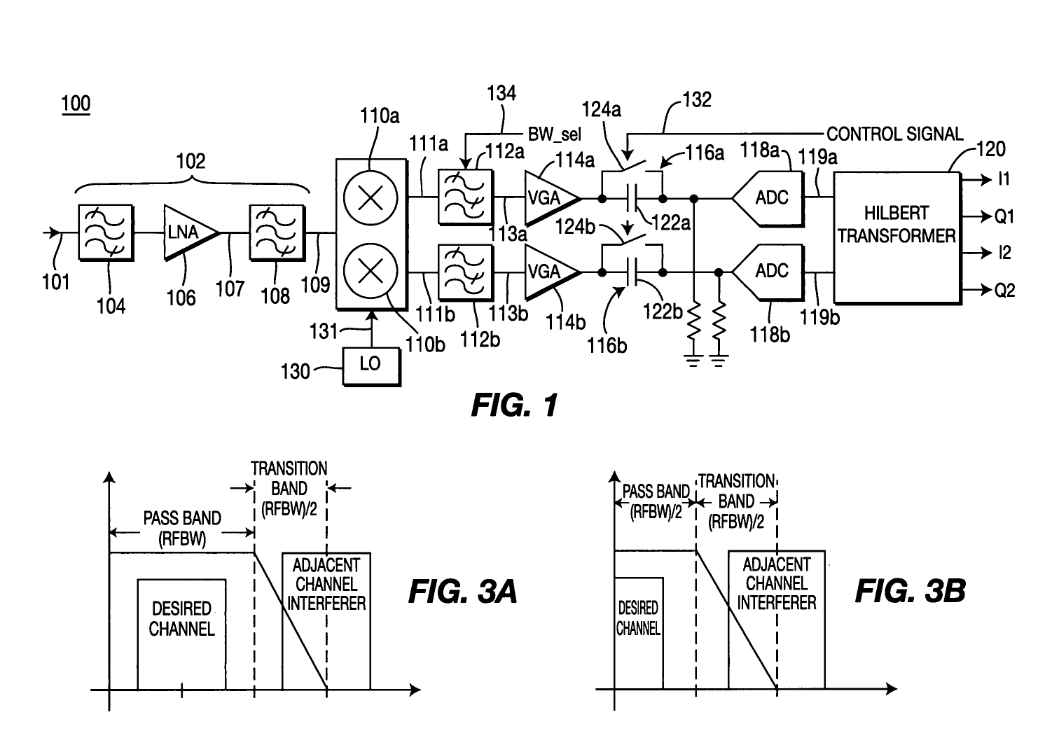

FIG. 1 is a block diagram of an exemplary receiver 100 for processing two adjacent channels simultaneously in accordance with the present invention. Hereinafter, the present invention will be explained with reference to a receiver configured to process two adjacent channels (dual channel mode). However, it should be noted that the present invention is also applicable to process only one channel (single channel mode) or more than two adjacent channels simultaneously, and the processing may be selectively switched between the single channel mode and the dual channel mode, which will be explained in detail hereinafter.

The receiver 100 comprises an analog front end 102, (including a first filter 104, a second filter 108 and a low noise amplifier (LNA) 106), mixers 110a, 110b, a third filter 112a, a fourth filter 112b, variable gain amplifiers (VGAs) 114a, 114b, coupling networks 116a, 116b, ADCs 118a, 118b, a Hilbert transformer 120 and a LO 130. It should be understood to be obvious to those of skill in the art that more or less components than those shown in FIG. 1 may be used.

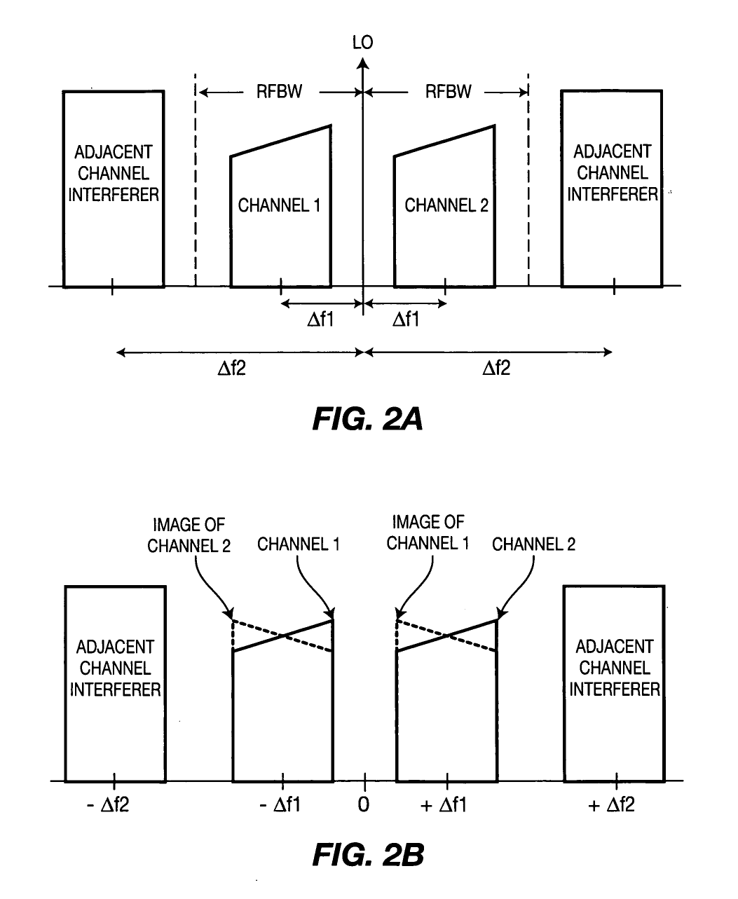

Signals 101 received by the receiver 100 include two adjacent channels of interest, for example channel 1 and channel 2. FIG. 2A shows an RF spectrum of the received signals 101 including the channel 1 and the channel 2 and adjacent channel interferers. The RF bandwidth (RFBW) of the channel 1 and channel 2, (including guard bands of the channel 1 and channel 2), are adjacent to each other as shown in FIG. 2. Referring to FIG. 1, the received signals 101 are filtered by the first filter 104 and amplified by the LNA 106 to generate an amplified signal 107, which is filtered again by the second filter 108 to generate a filtered signal 109. The filtered signal 109 is then input to the mixers 110a, 110b, which mix the filtered signals 109 with LO signals 131 generated by the LO 130 to generate down-converted signals 111a, 111b. The down-conversion may be performed by more than one step, which should be obvious to those of skill in the art. The mixer 110a is used to recover in-phase (I) channel signals and the mixer 110b is used to recover Quadrature (Q) channel signals. The I channel and Q channel signals are processed separately and simultaneously thereafter.

In accordance with the present invention, in a dual channel mode, the frequency of the LO signals 131 is tuned to the middle of channel 1 and channel 2. As shown in FIG. 2A, channel 1 and channel 2 are separated by 2Δf1 and the LO frequency is tuned to the center of the two center frequencies of the channels. Therefore, after down-conversion, the down-converted signals 111a, 111b of the two channels overlap each other, as shown in FIG. 2B.

Referring back to FIG. 1, after down-conversion, the down-converted signals 111a, 111b are filtered by the filters 112a, 112b, respectively, to remove all other image frequencies and noises. The bandwidth of the filters 112a, 112b are preferably adjustable in accordance with a bandwidth selection signal 134, which will be explained in detail hereinafter.

The filtered signals 113a, 113b are then amplified by VGAs 114a, 114b and fed to the ADCs 118a, 118b via the coupling networks 116a, 116b, respectively. Since the LO frequency is tuned to the center of the two center frequencies of the channels in a dual channel mode, the filtered signals 113a, 113b may be AC-coupled to the ADCs 118a, 118b through the coupling networks 116a, 116b, respectively. There are many benefits of AC-coupling of the analog baseband signals including, but not limited to, an increase of the second order intercept point (IP2), a rejection of 1/f noise, or the like

The coupling networks 116a, 116b include an AC-coupling and preferably a DC-coupling as well. The DC-coupling via the coupling network 116a, 116b is selectively switched on and off in accordance with the control signal 132 to either selectively DC-couple or AC-couple the filtered signals 113a, 113b to the ADCs 118a, 118b, respectively.

For example, the coupling network 116a, 116b includes a capacitor 122a, 122b coupled in series and a switch 124a, 124b coupled in parallel. The filtered signal 113a, 113b may be AC-coupled to the ADCs 118a, 118b through the capacitors 122a, 122b, respectively. The switch 124a, 124b may be turned on and off in accordance with the control signal 132 to selectively DC-couple the filtered signals 113a, 113b to the ADCs 118a, 118b, respectively.

The ADCs 118a, 118b output digitized values 119a, 119b of the input signals. Since channel 1 and channel 2 overlap, the output 119a of the ADC 118a is the digitized values of the mixture of I components, (i.e., I1 and I2), of the received signals and the output 119b of the ADC 118b is the digitized values of the mixture of Q components, (i.e., Q1 and Q2) of the received signals.

The Hilbert transformer 120 separates the I1 and I2 values from the output 119a and the Q1 and Q2 values from the output 119b. The Hilbert transformer 120 is well known in the art and will not be explained in detail herein. The recovered I1, I2, Q1 and Q2 values are then forwarded to downstream processors (not shown).

As stated above, the receiver 100 may operate either a single channel mode or a dual channel mode (or multi-channel mode). In the dual channel mode, the receiver 100 processes two channels simultaneously. In the single channel mode, the receiver 100 processed only one channel. For the single channel mode, the following is implemented: 1) the LO frequency is adjusted to the center of the channel of interest; 2) the bandwidths of the third filter 112a and the fourth filter 112b are adjusted in accordance with the bandwidth selection signal 134; 3) the coupling network 116a, 116b may be configured to DC-couple the down-converted signals 111a, 111b if necessary; and 4) the Hilbert transformer 120 is bypassed.

As shown in FIGS. 3A and 3B, the filtering requirements of the filters 112a, 112b for the dual channel mode and the single channel mode are different. The transition bands for both modes may be the same. However, since the LO frequency in the dual channel mode is tuned to the center of the center frequencies of the two adjacent channels but the LO frequency in the single channel mode is tuned to the center of the channel of interest, the pass band of the dual channel mode is twice as wide as the single channel mode. Therefore, a more complex filter is needed for filters 112a, 112b in the dual channel mode.

Additionally, the ADCs 118a, 118b may be configured to operate with extra bits, (e.g., 2 or 3 bits), compared to conventional ADCs to accommodate the possible difference in received signal strengths of the two adjacent channels.

The present invention is an enhancement to a conventional direct conversion single channel receiver with minimal additional analog and digital back end processing. In accordance with the present invention, the reception of two or more adjacent channels is facilitated and the receive processing is more flexible since the receiver is software configurable.

Although the features and elements of the present invention are described in the preferred embodiments in particular combinations, each feature or element can be used alone without the other features and elements of the preferred embodiments or in various combinations with or without other features and elements of the present invention.

What is claimed is:

1. An apparatus for processing multiple adjacent radio frequency (RF) channels simultaneously, the apparatus comprising:
an analog front end for receiving RF signals, the received RF signals including a plurality of channels adjacent to each other in frequency;
a local oscillator (LO) for generating LO signals;
a mixer for mixing the received RF signals with the LO signals to down-convert the RF signals, a frequency of the LO signals being tuned such that at least two channels in the down-converted signals overlap each other;
at least one filter for filtering the down-converted signals;
at least one analog-to-digital converter (ADC) for digitizing the filtered down-converted signals to generate digitized signals; and
a Hilbert transformer for recovering signals on each of the RF channels from the digitized signals.

2. The apparatus of claim 1 wherein the LO is software configurable.

3. The apparatus of claim 1 wherein the filter is software configurable.

4. The apparatus of claim 1 wherein the apparatus is configured to selectively process the received RF signals in a single channel mode, whereby only one channel of interest is processed.

5. The apparatus of claim 4 wherein the LO frequency is adjusted to the center of the channel of interest.

6. The apparatus of claim 5 wherein a bandwidth of the filter is adjusted in accordance with a bandwidth selection signal for the single channel mode.

7. The apparatus of claim 1 further comprising a coupling network for coupling the filtered down-converted signals to the ADC.

8. The apparatus of claim 7 wherein the coupling network provides an alternating current (AC)-coupling of the filtered down-converted signals to the ADC.

9. The apparatus of claim 7 wherein the coupling network selectively provides either direct current (DC)-coupling or alternating current (AC)-coupling in accordance with a control signal.

10. The apparatus of claim 9 wherein the coupling network comprises:
a capacitor coupled in series; and
a switch coupled in parallel, whereby the switch is turned on and off in accordance with the control signal.

11. The apparatus of claim 1 wherein the apparatus is a wireless transmit/receive unit (WTRU).

12. The apparatus of claim 1 wherein the apparatus is a base station.

13. The apparatus of claim 1 wherein the apparatus is an integrated circuit (IC).

14. A method for processing a plurality of adjacent radio frequency (RF) channels simultaneously in a receiver, the method comprising:
receiving RF signals including a plurality of RF channels adjacent to each other in frequency;
generating local oscillator (LO) signals;
mixing the received RF signals with the LO signals to generate down-converted signals, a frequency of the LO signals being tuned such that at least two channels in the down-converted signals overlap each other;
filtering the down-converted signals to generate filtered down-converted signals;
digitizing the filtered down-converted signals to generate digitized signals; and
recovering signals on each of the channels from the digitized signals.

15. The method of claim 14 wherein the frequency of the LO signals is software configurable such that the LO signals are generated in accordance with a control signal configuring the frequency of the LO signals.

16. The method of claim 14 wherein the filtering the down-converted signals is software configurable such that the down-converted signals are filtered with a bandwidth configured in accordance with a bandwidth selection signal.

17. The method of claim 14 wherein the frequency of the LO signals and the filtering are configured to process only one channel of interest among the plurality of channels.

18. The method of claim 17 wherein the frequency of the LO signals is tuned to the center of the channel of interest.

19. The method of claim 14 wherein the filtered down-converted signals are alternating current (AC)-coupled to be digitized.

20. The method of claim 14 wherein the filtered down-converted signals are either direct current (DC)-coupled or alternating current (AC)-coupled selectively in accordance with a control signal.
